(19) United States
(12) Patent Application Publication
(10) Pub. No.: US 2006/0149804 A1
(43) Pub. Date: Jul. 6, 2006

(54) Multiply-sum dot product instruction with mask and splat

(75) Inventors: David A. Luick, Rochester, MN (US); Eric O. Mejdrich, Rochester, MN (US)

Correspondence Address: IBM CORPORATION;DEPT 917, 3605 HIGHWAY 52 NORTH, ROCHESTER, NY, 55901-7829, US

(73) Assignee: International Business Machines Corporation, Armonk, NY (US)

(21) Appl. No.: 11/000,437

(22) Filed: Nov. 30, 2004

(51) Int. Cl. G06F 7/52

(52) U.S. Cl. 708/626

(57) ABSTRACT

An instruction, corresponding methods, and circuitry for efficiently performing partial dot sum products are provided. The instruction may include a source select field for specifying one or more source word elements to participate in the dot sum operation. The instruction may also include a target select field for specifying one or more (or none) target word elements for storing the result of the dot sum operation.

### BACKGROUND OF THE INVENTION

1. Field of the Invention

The present invention generally relates to data processing and, more particularly to an efficient implementation of an instruction for performing a math operation.

2. Description of the Related Art

A system on a chip (SOC) generally includes one or more integrated processor cores, some type of embedded memory, such as a cache shared between the processors cores, and peripheral interfaces, such as memory control components and external bus interfaces, on a single chip to form a complete (or nearly complete) system. The processor cores may each include any number of different type functional units including, but not limited to arithmetic logic units (ALUs), floating point units (FPUs), and single instruction-multiple data (SIMD) units. Examples of CPUs utilizing multiple processor cores include the PowerPC® line of CPUs, available from International Business Machines (IBM) of Armonk, N.Y.

SIMD generally refers to operations for efficiently handling large quantities of data in parallel, as in vector or array processing. SIMD operations, as contrasted to multiple instruction-multiple data operations, were historically utilized in large scale supercomputers, but have recently been available in SOCs utilized in more standard applications, such as in personal computers (PCs), personal digital assistants (PDAs), and gaming systems.

One example of a SIMD instruction is a dot product instruction in which multiple source elements are multiplied together and summed. This instruction may be used, for example, in a graphics application to change a feature of an image (e.g., brightness, shading, etc.). Each pixel of the image may consist of three N-bit values for the brightness of the red (R), green (G), and blue (B) portions of the color, as well as a fourth N-bit value for a texture, which may be contained as word elements (W, X, Y, and Z) in a single (4×N-bit) register. For example, four 32-bit (4 byte) word elements with pixel value data may be contained in a single 128-bit (16 byte) register. The dot product of two registers R1 (W1, X1, Y1, Z1) and R2 (W2, X2, Y2, Z2) may be defined by the following equation:
DP=W1*W2+X1*X2+Y1*Y2+Z1*Z2
In many cases, however, it may be desirable to only perform a “partial” dot product, for example, with only the RGB pixel values (and not the texture value) participating in the operation. Further, it may be desirable to have the result modify only one or some word elements of a target register.

FIG. 1A is a flow diagram of exemplary operations 10 for performing such a partial dot product with variable element modification in accordance with the prior art. The operations 10 begin, at step 12, by preparing the source registers to select the desired word elements to participate in the dot product prior to executing the dot product instruction. Continuing with the example above, a pixel value may be loaded into a source register and the texture value masked by writing a zero value to that word element. At step 14, the dot product instruction is executed, generating a scalar (word length) result. As described above, it may be desirable to modify only one or some of the target word elements with the result. At step 16, the result is stored in a targeted word element. If there are no more target elements, the operations 10 are terminated, at step 19.

On the other hand, if there are more targeted word elements, as determined at step 18, additional instructions may need to be executed (e.g., loading, shifting, and storing), to store the result to the additional target elements. These are in addition to the instructions that may be required (at step 12) to select word elements for a partial dot product sum. Thus, such partial and variable element modification requires several additional instructions which may significantly reduce performance.

Accordingly, what is needed is an improved method and technique for performing SIMD instructions, such as dot product sums.

### SUMMARY OF THE INVENTION

The present invention generally provides methods and circuits for generating a dot product sum.

One embodiments provides a method of generating a dot product sum. The method generally includes receiving an instruction specifying at least two source registers and a target register, generating a dot product sum by multiplying word elements contained in each source register and summing the products of the multiplication, wherein the word elements that participate in the multiplication are specified by one or more bits in the instruction, and storing the dot product sum in none, one, or more word elements contained in the target register.

Another embodiment provides a method of generating a dot product sum with accumulate. The method generally includes receiving an instruction specifying at least two source registers and a target register, generating a dot product sum by multiplying word elements contained in each source register and summing the products of the multiplication, wherein the word elements that participate in the multiplication are specified by one or more bits in the instruction. adding the dot product sum to a value contained in an accumulate register to generate an accumulated sum, and storing the accumulated sum in none, one, or more word elements contained in the target register.

Another embodiment provides a circuit for executing a dot product sum instruction. The circuit generally includes mask logic configured to select word elements from at least two source registers to participate in a calculation of a dot product sum based on one or more bits contained in the instruction, multiply sum logic configured to perform the calculation of the dot product sum based on the word elements selected by the mask logic, and target routing logic configured to store the dot product sum calculated by the multiply sum logic in none, one, or all word elements of a target register.

Another embodiment provides a circuit for executing a dot product sum with accumulate instruction. The circuit generally includes mask logic configured to select word elements from at least two source registers to participate in a calculation of a dot product sum based on one or more bits contained in the instruction, multiply-sum-accumulate logic configured to perform the calculation of the dot product sum based on the word elements selected by the mask logic and add the dot product sum to the contents of an accumulate register to generate an accumulated sum, and target routing logic configured to store the accumulated sum in none, one, or all word elements of a target register.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B are flow diagrams of operations for performing a partial dot product in accordance with the prior art and in accordance with an embodiment of the present invention, respectively.

FIG. 2 illustrates an exemplary system including an exemplary system on chip (SOC), in which embodiments of the present invention may be utilized.

FIG. 3 illustrates an exemplary dot product instruction having source mask and target selection fields, in accordance with an embodiment of the present invention.

FIG. 4 illustrates an exemplary diagram of circuitry capable of carrying out a partial dot product, according to one embodiment of the present invention.

FIG. 5 illustrates an exemplary diagram of circuitry capable of carrying out a partial dot product with accumulate, according to one embodiment of the present invention.

### DETAILED DESCRIPTION OF THE PREFERRED EMBODIMENTS

Embodiments of the present invention generally provide an instruction (and corresponding circuitry) for efficiently performing partial dot sum products. The instruction may include a word select for specifying one or more source word elements to participate in the dot sum operation. The instruction may also include a target select field for specifying one or more (or none) target word elements for storing the result of the dot sum operation.

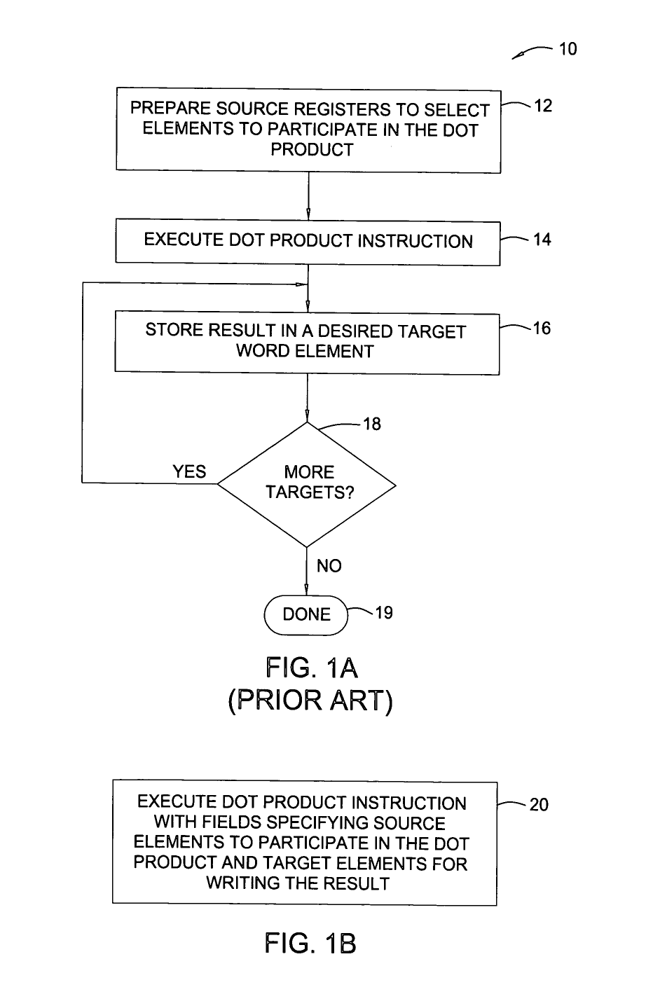

Utilizing such an instruction, a partial dot product sum may be performed on a select number of source word elements, with the result stored in a select number of target word elements, in a single operation 20 (shown in FIG. 1B). In other words, several of the operations shown in the flow diagram of FIG. 1A may be combined into a single instruction, which may significantly improve performance.

Such an instruction may be implemented in various devices (e.g., central processing units and graphics processing units) in a wide variety of different applications. However, to facilitate understanding, embodiments of the present invention will be described below with reference to a system on a chip (SOC) utilized in a graphics processing environment as a specific, but not limiting, application example. Further, the concepts described herein may be applied regardless of the format of the instruction operations (e.g., fixed point or floating point).

### An Exemplary System

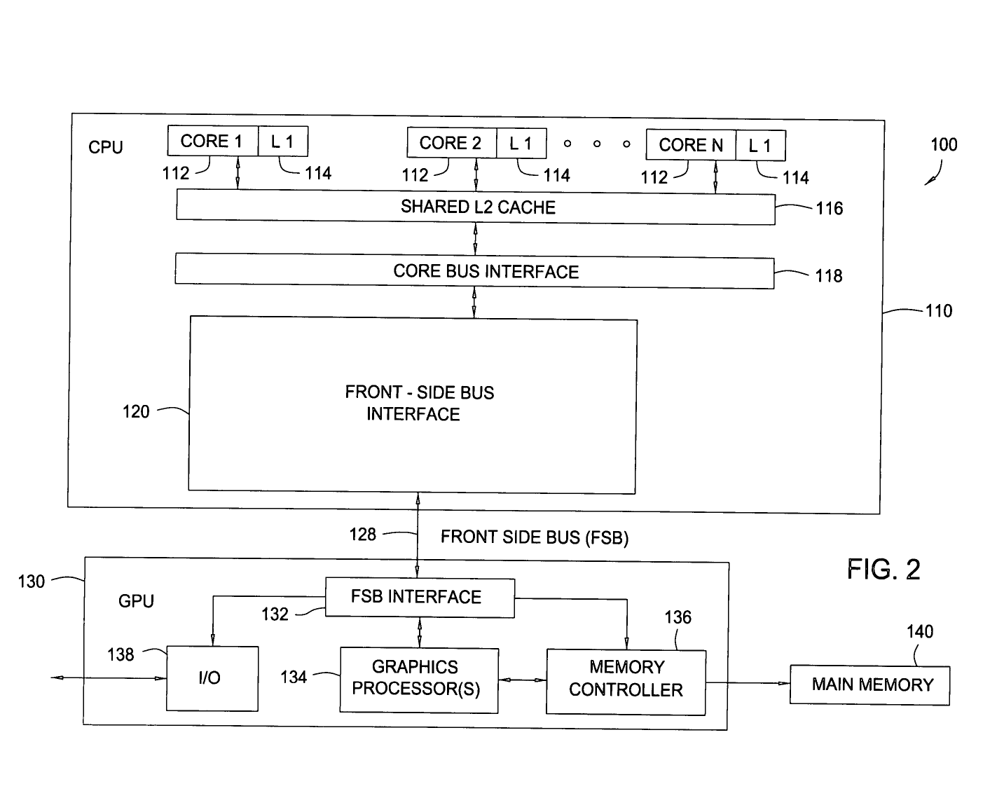

Referring now to FIG. 2, an exemplary computer system 100 including a CPU system on chip (SOC) 110 is illustrated, in which embodiments of the present invention may be utilized. As illustrated, the SOC 110 may have one or more processor cores 112, which may each include any number of different type functional units including, but not limited to arithmetic logic units (ALUs), floating point units (FPUs), and single instruction multiple data (SIMD) units. Examples of SOCs utilizing multiple processor cores include SOCs incorporating the PowerPC® line of CPUs, available from International Business Machines (IBM) of Armonk, N.Y.

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external memory (e.g., non-volatile memory 140 and volatile memory 145). Similarly, data utilized often by a processor core 112 may be stored in its L1 cache 114, preventing or reducing the number of relatively slower accesses to the L2 cache 116.

The SOC 110 may communicate with external devices, such as a graphics processing unit (GPU) 130 and/or a memory controller 136 via a system or frontside bus (FSB) 128. The SOC 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130).

The FSB interface 120 may include any suitable components, such as a physical layer (not shown) for implementing the hardware protocol necessary for receiving and sending data over the FSB 128. Such a physical layer may exchange data with an intermediate “link” layer which may format data received from or to be sent to a transaction layer. The transaction layer may exchange data with the processor cores 112 via a core bus interface (CBI) 118.

According to some applications, the SOC 110 may generate graphics (e.g., pixel) data for use by the GPU 130. For example, the SOC 110 may execute code (sets of instructions) that generates pixel data based on geometric representations of image elements, described by a set of vertices/origins and mathematical equations. In such cases, partial dot products may be performed as part of pixel data generation and/or manipulation. For some applications, these operations may be performed by the GPU 130 instead, or in addition. Accordingly, embodiments of the present invention may be incorporated in the processor cores 112 of the SOC 110 or graphics processor cores 134 of the GPU 130, as logic capable of executing the partial dot product instruction described herein.

### A Partial Dot Product Instruction

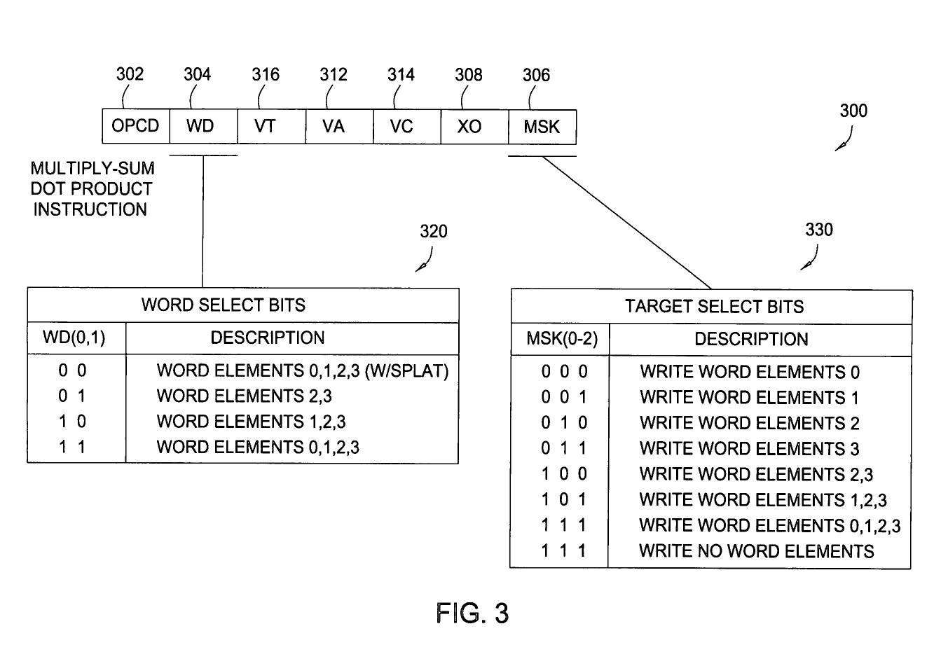

FIG. 3 illustrates an exemplary dot product instruction 300 in accordance with embodiments of the present invention. As illustrated, the instruction may include an opcode field 302, an extended opcode field 308, source register fields 312-314, and a target register field 316. The register fields may comprise any suitable number of bits to specify source and target registers and the exact number of bits may depend on a particular system architecture. For example, 5-bit register fields may be used to specify one of 32 source and target registers, while 7-bit register fields may be used to one of 128 source and target registers. Further, for some embodiments, source and/or target registers may each be specified by a combination of fields (e.g., with multiple fields concatenated to specify a register).

As previously described, while the dot product operation conventionally generates a sum of products of individual word elements of each source register (e.g., W1*W2+X1*X2+Y1*Y2+Z1*Z2), it is often desirable to generate partial dot products, with only some of the word elements participating in the result. To this effect, the instruction 300 may include a field 304 with bits for specifying which source word elements are to participate in the dot product. The instruction 300 may also include a field 306 with bits for specifying none, one, or more target word elements for writing the result of the dot product.

Table 320 illustrates how a two-bit source word element select field 304 may be utilized to select different combinations of source word elements. As shown, for some embodiments, two bit-field combinations may select the same set of source word elements, but with one of the two also effecting the target field (as shown 00 specifies that the result be written to all target word elements, referred to herein as a SPLAT write).

Table 330 illustrates how a three-bit target word element select field 306 may be utilized to select different combinations of target word elements. Of course the exact combination of target word elements is illustrative only and the actual combinations implemented may be selected based on the most useful operations. It should be noted that, as shown by the last entry (111), in some cases it may be desirable to specify no target word elements for writing, for example, in order to perform a conditional test on one or more status bits (e.g., zero, carry, etc.) effected by the operation.

Of course, the actual number of bits for each of the fields 304-306 may vary, for example, depending on the desired flexibility, as well as the number of available bits in the instruction 300. For some embodiments it may be necessary, in effect, to “borrow” some of the opcode bits 302 or extended opcode bits 308 for source and/or target word element selection. For example, with a 32-bit instruction with 7-bit register fields 312-316, the number of bits remaining for the opcode fields 302 and 308 and source/target word element select fields 304-306 may be limited. In such cases, a range of opcodes may be used for dot products, with each opcode in the range selecting a different combination of source and/or target word elements.

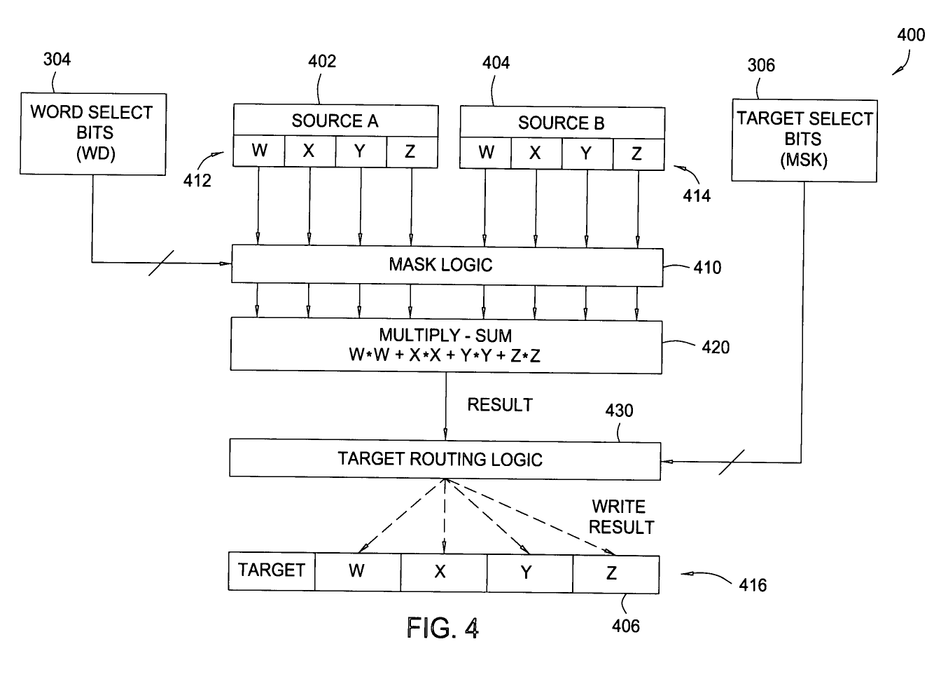

FIG. 4 illustrates exemplary circuitry 400 for implementing the instruction 300 shown in FIG. 3. For example, the circuitry 400 may be included as part of a floating point or SIMD unit in a processor core 112 of the SOC 110 or graphics processor core 134 of the GPU shown in FIG. 1. The circuitry 400 is configured to perform a dot product on word elements 412 and 414 contained in source registers 402 and 404, respectively and write the results to one or more word elements 416 of a target register 406. The source registers 402-404 and target register 406 may be specified by fields 312-314, and 316, respectively, in the instruction 300.

As shown, mask logic 410 may be configured to select word elements 412 and 414 of source registers 402 and 404, respectively, to participate in the dot product operation, based on source word element select bits 304. For example, the mask logic 410 may be configured to mask word elements 412-414 that are not selected by writing a floating point zero, such that the masked elements 412-414 will not contribute to the dot product.

The mask logic 410 may output selected (e.g., non-masked) word elements to multiply sum logic 420 which performs the actual dot product operation and outputs the result to target routing logic 430. As illustrated, the target routing logic 430 may write the result to none or more target word elements 416, based on target word element select bits 306.

### A Partial Dot Product with Accumulate

In some cases, it may be desirable to keep a running sum of a series of dot product operations. For some embodiments, this may be accomplished utilizing a dot product with accumulate instruction that maintains the running sum in an accumulate register. For such embodiments, it may be desirable to have the same type of flexibility in selecting source and/or target word elements, as described herein. Further flexibility may be added, as well, for example by allowing a selection of whether the accumulate register is modified by the result. For example, for some operations involving a series of accumulated dot product sums, it may be desirable to generate a final partial dot product based on two source registers and the accumulate register, for example, without overwriting the accumulate register.

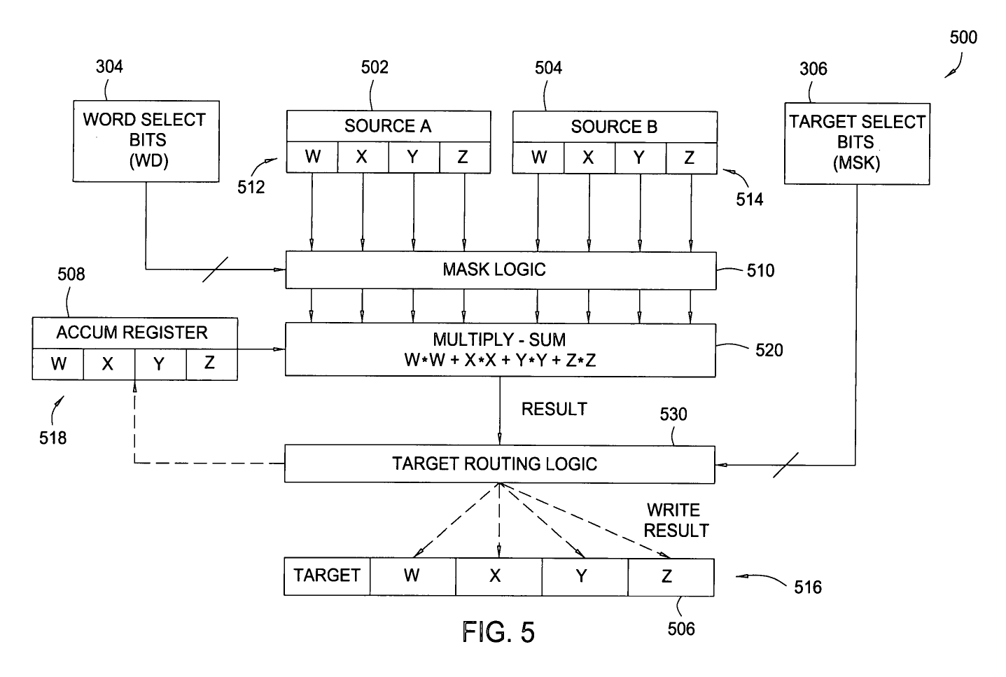

FIG. 5 illustrates exemplary circuitry 500 for implementing a dot product with accumulate instruction, in accordance with one embodiment of the present invention. As illustrated, the circuitry 500 is configured to perform a dot product with accumulate on word elements 512 and 514 contained in source registers 502 and 504, respectively, add the dot product to the contents of an accumulate register 508 and write the results to one or more word elements 516 of a target register 506.

As described above, mask logic 510 may be configured to select word elements 512 and 514 of source registers 502 and 504, respectively, to participate in the dot product with accumulate operation, based on source word element select bits 304. In effect, the accumulate register 508 may be considered a third source register. Accordingly, for some embodiments, one or more bits in the instruction may be used to select a word element 518 of the accumulate register 508 to hold the accumulated dot product.

Regardless, the mask logic 510 may output selected (e.g., non-masked) word elements to multiply sum accumulate logic 520 which performs the actual dot product calculation, adds the dot product sum to the contents of the accumulate register 506, and outputs the accumulated sum to target routing logic 530. The target routing logic 530 may write the accumulated sum to none or more target word elements 516 of the target register 506, based on target word element select bits 306. As illustrated, the target routing logic may also write the accumulated sum to the accumulate register 508. However, for some embodiments, one or more bits in the instruction (e.g., in the target word element select field 306), may be used to prevent the accumulate register 508 from being overwritten.

### CONCLUSION

By providing an dot product instruction with a field for selecting source word elements to participate in the operation and/or a field for selecting target word elements for writing the result of the operation, operations previously requiring several instructions may be combined in a single instruction. As a result, system performance may be improved significantly.

While the foregoing is directed to embodiments of the present invention, other and further embodiments of the invention may be devised without departing from the basic scope thereof, and the scope thereof is determined by the claims that follow.

What is claimed is:

1. A method of generating a dot product sum, comprising:
receiving an instruction specifying at least two source registers and a target register;
generating a dot product sum by multiplying word elements contained in each source register and summing the products of the multiplication, wherein the word elements that participate in the multiplication are specified by one or more bits in the instruction; and
storing the dot product sum in none, one, or more word elements contained in the target register.

2. The method of claim 1, wherein storing the dot product sum comprises storing the dot product sum in none, one, or more word elements, as specified by one or more bits in the instruction.

3. The method of claim 1, wherein the instruction comprises:
a first bit field for specifying source word elements to participate in the dot product sum; and
a second bit field for specifying none or more target word elements for storing the dot product sum.

4. The method of claim 1, wherein each word element contains a floating point number.

5. The method of claim 4, wherein generating the dot product sum comprises masking one or more word elements that do not participate in the multiplication, as specified by one or more bits in the instruction, by replacing those word elements with floating point zero values.

6. The method of claim 1, wherein storing the dot product sum in none, one, or more word elements contained in the target register comprises storing the dot product sum in all word elements contained in the target register, if specified by one or more bits contained in the instruction.

7. The method of claim 1, wherein the one or more bits are contained in a field separate from an opcode field.

8. A method of generating a dot product sum with accumulate, comprising:
receiving an instruction specifying at least two source registers and a target register;
generating a dot product sum by multiplying word elements contained in each source register and summing the products of the multiplication, wherein the word elements that participate in the multiplication are specified by one or more bits in the instruction;
adding the dot product sum to a value contained in an accumulate register to generate an accumulated sum; and
storing the accumulated sum in none, one, or more word elements contained in the target register.

9. The method of claim 8, further comprising:
storing the accumulated sum in the accumulate register, only if specified by one or more bits contained in the instruction.

10. The method of claim 8, wherein storing the accumulated sum comprises storing the accumulated sum in none, one, or more word elements, as specified by one or more bits in the instruction.

11. The method of claim 10, wherein the instruction comprises:
a first bit field for specifying source word elements to participate in the dot product sum; and
a second bit field for specifying none or more target word elements for storing the accumulated sum.

12. A circuit for executing a dot product sum instruction, comprising:
mask logic configured to select word elements from at least two source registers to participate in a calculation of a dot product sum based on one or more bits contained in the instruction;
multiply sum logic configured to perform the calculation of the dot product sum based on the word elements selected by the mask logic; and
target routing logic configured to store the dot product sum calculated by the multiply sum logic in none, one, or all word elements of a target register.

13. The circuit of claim 12, wherein the target routing logic is configured to store the dot product sum in none, one, or more word elements, as specified by one or more bits in the instruction.

14. The circuit of claim 12, wherein the instruction comprises:
a first bit field for specifying source word elements to participate in the dot product sum; and
a second bit field for specifying none or more target word elements for storing the dot product sum.

15. The circuit of claim 12, wherein each word element contains a floating point number.

16. The circuit of claim 15, wherein the masking logic is configured to mask one or more word elements that do not participate in the multiplication, as specified by one or more bits in the instruction, by replacing those word elements with floating point zero values.

17. The circuit of claim 12, wherein the routing logic is configured to store the dot product sum in all word elements contained in the target register, if specified by one or more bits contained in the instruction.

18. A circuit for executing a dot product sum with accumulate instruction, comprising:
mask logic configured to select word elements from at least two source registers to participate in a calculation of a dot product sum based on one or more bits contained in the instruction;
multiply-sum-accumulate logic configured to perform the calculation of the dot product sum based on the word elements selected by the mask logic and add the dot product sum to the contents of an accumulate register to generate an accumulated sum; and
target routing logic configured to store the accumulated sum in none, one, or all word elements of a target register.

19. The circuit of claim 18, wherein the target routing logic is configured to store the accumulated sum in the accumulate register, only if specified by one or more bits contained in the instruction.

20. The circuit of claim 18, the target routing logic is configured to store the accumulated sum in none, one, or more word elements, as specified by one or more bits in the instruction.

21. The method of claim 20, wherein the instruction comprises:
a first bit field for specifying source word elements to participate in the dot product sum; and
a second bit field for specifying none or more target word elements for storing the accumulated sum.
